(19) United States
(12) Patent Application Publication
(10) Pub. No.: US 2017/0282263 A1
(43) Pub. Date: Oct. 5, 2017

(54) TUBULAR CUTTING APPARATUS

(71) Applicant: John J. Khoury, Houston, TX (US)

(72) Inventors: John J. Khoury, Houston, TX (US); Leon Ortemond, Abbeville, LA (US)

(21) Appl. No.: 15/627,030

(22) Filed: Jun. 19, 2017

Related U.S. Application Data
(63) Continuation-in-part of application No. 13/385,668, filed on Feb. 29, 2012, now abandoned.
Application No. 13/385,668 is a continuation-in-part of application No. 11/804,305, filed on May 16, 2007, now abandoned.

(51) Int. Cl. B23D 15/14; E02D 9/04; B23D 35/00; B23D 15/04; B23D 21/00

(52) U.S. Cl. CPC B23D 15/14; B23D 15/04; B23D 21/00; B23D 35/001; E02D 9/04

(57) ABSTRACT

An apparatus for cutting off concrete, wooden, and/or metal piles, casing, conductor pipe and other metal tubulars, uses a metal frame and a metal blade linearly moveable within the frame, the blade being hydraulically and/or pneumatically driven to puncture and then slice and split through the metal being cut off, the cutting surface of the blade having a removable, centralized puncture point located essentially at the projected intersection between two concave cutting surfaces.

This application is a continuation-in-part of and claims priority to U.S. patent application Ser. No. 13/385,668, filed 29 Feb. 2012, which in turn is a continuation-in-part of and claims priority to U.S. patent application Ser. No. 11/804,305 filed on 16 May 2007. All parent applications are herein incorporated in their entirety by reference.

### BACKGROUND OF THE INVENTION

This disclosure relates, generally, to a new and improved machine for cutting metal structure, typically made from steel, which have been partially destroyed during offshore storms which often times prevent the structures from being moved to another location. These structures take a variety of forms, but can include drill ships, drilling platforms, steel casing and risers, but will also include various other forms, including metal piles used to anchor and support offshore platforms, and the associated well casing and conductor pipe arrangements.

Another embodiment of the new and improved machine relates, generally, to cutting objects, typically made from steel or concrete with steel reinforcement, which can include drilling platforms, steel casing and risers, concrete pilings and risers.

Several mechanical cutting devices have been developed over the past 25-30 years that employ the use of hydraulic rams to cause a cutting blade to sever trees and concrete piles.

For example, U.S. Pat. Nos. 5,139,006, 5,245,982, and 5,413,086 to Trudeau illustrate machines for cutting concrete piles.

U.S. Pat. No. 7,243,646 to James J. Todack discloses another machine for shearing concrete and metal piles.

U.S. Pat. No. 4,261,399 to James B. Hawkins, et al, discloses a machine for cutting piling, trees or the like, and allows the machine to be opened up and placed around the tree or piling, as opposed to lowering the machine over the piling or cutting.

U.S. Pat. No. 7,351,010 to John M. Kelly, et al, discloses a machine having frame surrounding a pair of opposing blades with a gate to allow the machine to be opened and place around a section of pipeline and then closed for cutting operations.

### BRIEF DESCRIPTION OF THE DRAWINGS

FIG. 1A is an isometric, top view of an embodiment of a cutting machine according to the disclosure;

FIG. 1B is an isometric, bottom view of an embodiment of a cutting machine similar to that illustrated in FIG. 1A, this embodiment includes a centralizer located within the open portion of the frame between the gate and blade;

FIG. 2A is a schematic, elevated view of an embodiment of a cutting blade according to the disclosure;

FIG. 2B is a schematic, elevated view of an embodiment of a cutting blade according to the disclosure having traveled further through the tubular than is illustrated in FIG. 2A;

FIG. 3A is a partial, top plan view of an embodiment of a double-pronged cutting blade according to the disclosure;

FIG. 3B is a front view of a double-pronged cutting blade according to the disclosure illustrated in FIG. 3A;

FIG. 3C is a side view of an embodiment of one of the prongs of the double-pronged cutting blade according to the disclosure illustrated in FIGS. 3A and 3B;

FIG. 4A is a partial top plan view of an alternative embodiment of a cutter blade having a puncture point according to the disclosure;

FIG. 4B is a front view of the cutter blade according to FIG. 4A;

FIG. 4C is a side view of the cutter blade according to FIG. 4A;

FIG. 5A is an elevated view of a cross-member used in the frame of the cutting machine according to FIG. 1A;

FIG. 5B is an elevated view of a second cross-member used in the frame of the cutting machine according to FIG. 1A;

FIG. 6 is an exploded view of the gate assembly used in the cutting machine illustrated in FIG. 1A;

FIG. 7 is an isometric view of the gate assembly, illustrated in FIG. 6, following the assembly of the gate;

FIG. 8A is an isometric view of the latch assembly used in accordance to the present disclosure to keep the gate closed while a metal tubular or other object is being cut;

FIG. 8B is a top plan view of the latch assembly illustrated in FIG. 8A;

FIG. 9 is an isometric view of an embodiment of a cutting device of the present disclosure implementing an embodiment of a pair of v-shaped cutting blades;

FIG. 10 is an isometric view of an embodiment of a centralizer for use with the present invention;

The depicted embodiments of the invention are described below with reference to the listed Figures.

### DETAILED DESCRIPTION OF PREFERRED EMBODIMENTS OF INVENTION

Before explaining the present embodiments in detail, it is to be understood that the embodiments are not limited to the particular descriptions and that the embodiments can be practiced or carried out in various ways.

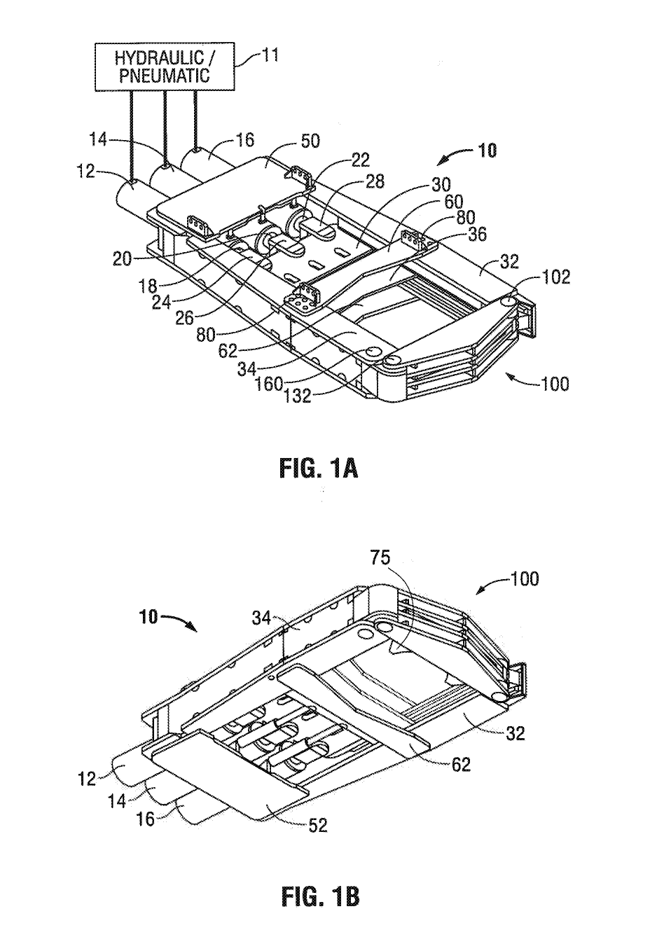

Referring now to FIGS. 1A and 1B of the drawings, there is illustrated two (2) isometric views, FIG. 1A as viewed from the top and FIG. 1B a separate embodiment as viewed from the bottom, of the cutting machine 10 according to the disclosure. The machine 10 includes three (3) hydraulic cylinders 12, 14 and 16 having pistons 18, 20 and 22, respectively, which can operate with hydraulic and/or pneumatic pressure from the conventional source 11. Previous hydraulic or pneumatic pistons used for cutting tools failed to provide a constant pressure through the operation, wherein the pressure would increase or decrease through the cutting operation depending on the resistance encountered by the cutting blade. The hydraulic and/or pneumatic pistons of the present disclosure are designed to provide a constant pressure force throughout the cutting operation.

The cutting blade 30, described in greater detail hereinafter, is connected to pistons 18, 20 and 22 by the arms 24, 26 and 28, respectively. The number of arms connecting the pistons to the cutting blade or a blade carrier can vary depending on the number of pistons used in a particular cutting machine.

In operation, the cutting blade 30 moves back and forth within the frame formed, in part, by frame members 32 and 34, as the pistons 18, 20 and 22 reciprocate within the cylinders 12, 14, and 16.

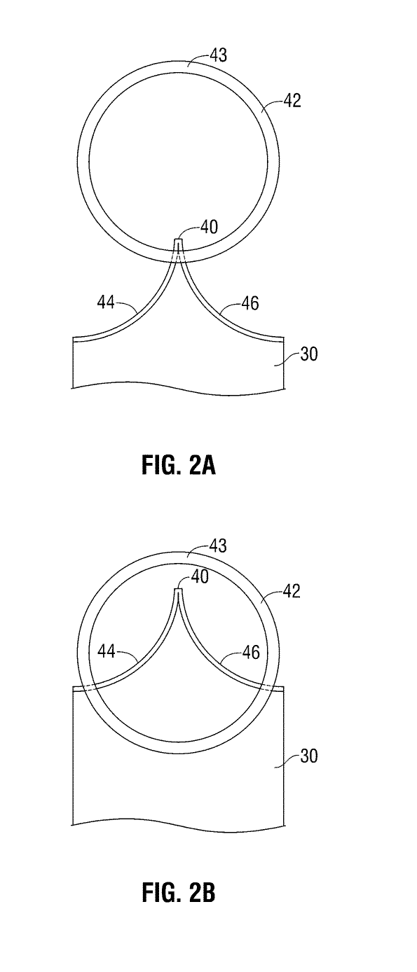

It should be appreciated that the cutting edge 36 of the cutter is preferably not straight, as illustrated in FIG. 1A but preferably is as illustrated in FIGS. 2A and 2B.

Referring now to FIGS. 2A and 2B, there is illustrated a schematic version of the preferred embodiments of the cutting blade 30. The cutting surface of the blade 30 has a pointed end 40 which punctures or penetrates a steel casing 42 in FIG. 2A. The cutting surface also includes a pair of concave surfaces 44 and 46, which together lead up to the puncture point 40. Thus, the puncture point 40 is located at the projected point of intersection of the concave surfaces 44 and 46. The radius of curvature for the surfaces 44 and 46 can be the same, or slightly different, if desired, but preferably are in the range of about 10″ to about 25″, an even more preferably have a radius of curvature either between about 11.85″ and 11.91″, or between about 23.7″ to 23.82″. However, the disclosure contemplates either or both of the concave surfaces 44 and 46 can have a radius of curvature of less than 10″ or greater than 25″. The curvature of the cutting surfaces reduces the tendency of a metal tubular to mash or bend during a cutting or shearing procedure, and instead produces a clean shear across the metal tubular.

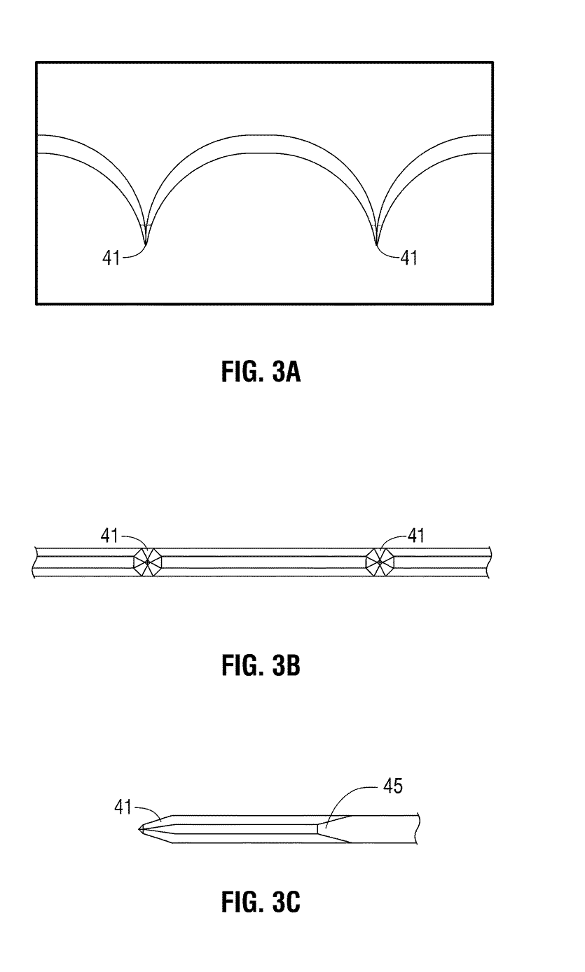

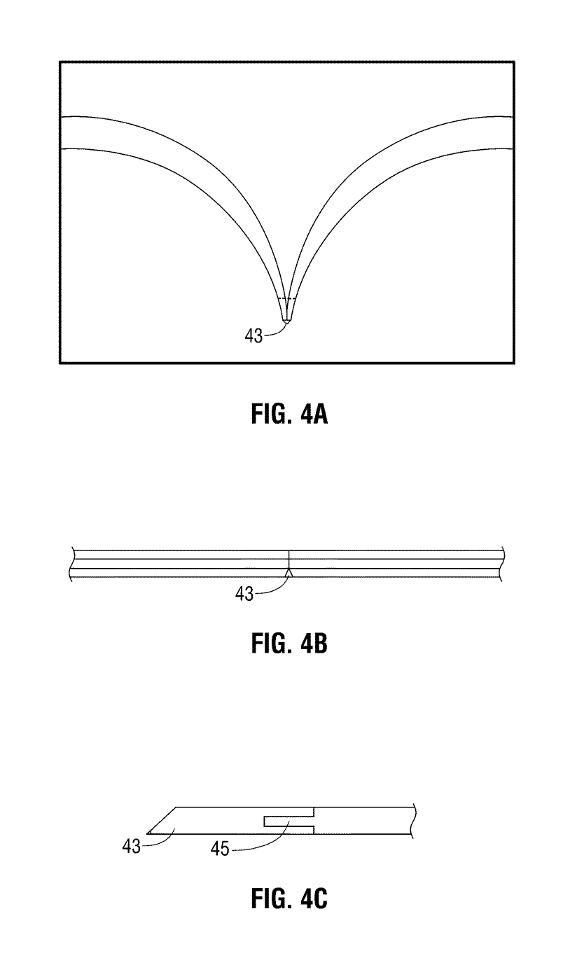

The puncture point 40 can additionally include a removable tip 41, which is easily replaceable, such as illustrated in FIGS. 3A, 3B and 3C, or a removable tip 43, which can be easily replaced, in FIGS. 4A, 4B and 4C. The removable tip 41 can be of the form of a cap or sleeve that fits over a formed point 45 or may be of a design that allows the entire tip to be removed from the blade and replaced through a slotted design or through fasteners (not shown).

The removable tip 41 or 43 allows the cutting blade 30 to continue being used in the event the removable tip is damaged when puncturing hard metals such as the steel casing 42 in FIGS. 2A and 2B. The removable tips are readily replaceable, allow for cutting operations to resume with minimal downtime, and avoids the need to retool and replace an entire cutting blade in the event of the puncture point becoming damaged.

In operation, because of the angle created along the sides of the puncture point 40, as illustrated in FIG. 2A, due to the concave cutting surfaces 44 and 46, the surfaces tend to slice through the metal casing 42 instead of mashing the metal casing. As the cutter 30 moves through the casing, as shown in FIG. 2B, the angle of the cutting surfaces continues to slice and then split through the casing 42. Although not illustrated, the further movements of the cutter 30 will cause the tip 40 to again puncture the casing 42 at location 43 on the casing, roughly 180° from the initial junction illustrated in FIG. 2A and for the surfaces 44 and 46 to completely cut through the casing 42.

Referring further to FIGS. 1A and 1B, the frame of the cutting machine 10 having the members 32 and 34, also has a top plate 50 (FIG. 1A) and a lower plate 52 (FIG. 1B) which are each mounted to each of the frame members 32 and 34 to provide mechanical stability to the frame. The frame members 32 and 34 are preferable parallel to each other. The plates 50 and 52 are also preferably parallel to each other. The plates 50 and 52 are mounted to the members 32 and 34 by any conventional fasteners, but preferably by welding. The frame members 32 and 34, as well as the plates 50 and 52 are preferably manufactured from hard metal such as, for example, case-hardened steel. For use in offshore environments, usually salt water, the entire cutting machine 10 is preferably coated, painted or otherwise treated to be rust resistant to the salt water. The invention contemplates that when the cutting machine 10 is used to cut metal piles, metal casing or the like, underneath the surface of the water, the machine 10, as well as the source 11 for the hydraulic and/or pneumatic pressure can be mounted on an underwater skid which can be moved along underneath the surface of the water by one (1) or more divers in a manner well known in the diving industry.

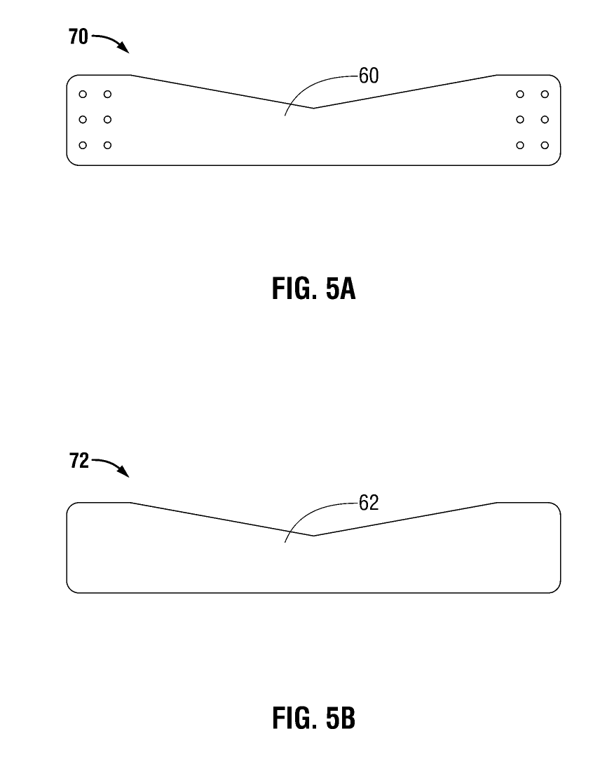

Also in FIGS. 1A and 1B, the machine 10 has a pair of plates 60 and 62, each of which is mounted to the frame members 32 and 34, and each of which has a V-shaped front surface 70 and 72, respectively as shown in FIGS. 5A and 5B, for engaging the casing 42 or other metal to be cut. The plates 60 and 62 are shown in greater detail in FIGS. 5A and 5B, respectively. The plates 60 and 62 are mounted by conventional fasteners, such as bolts, or by welding to the frame members 32 and 34. If bolted, the plates 60 and 62 can be moveably positioned along the frame members 32 and 34 to provide a more secure grip of the tubular being cut. The plates 60 and 62 provide additional stability and rigidity to the frame including members 32 and 34, as well as plates 50 and 52. Plates 60 and 62 can further provide attachment points 80 for a crane or other lifting device to pick up the cutting via wires, rope, or other suspension mechanism and move then provide lateral or vertical movement of the cutting machine 10.

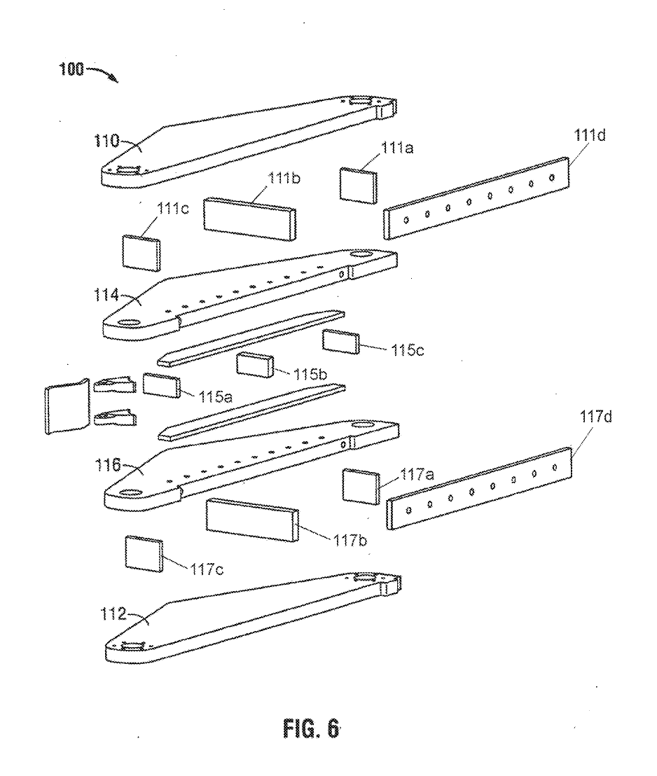

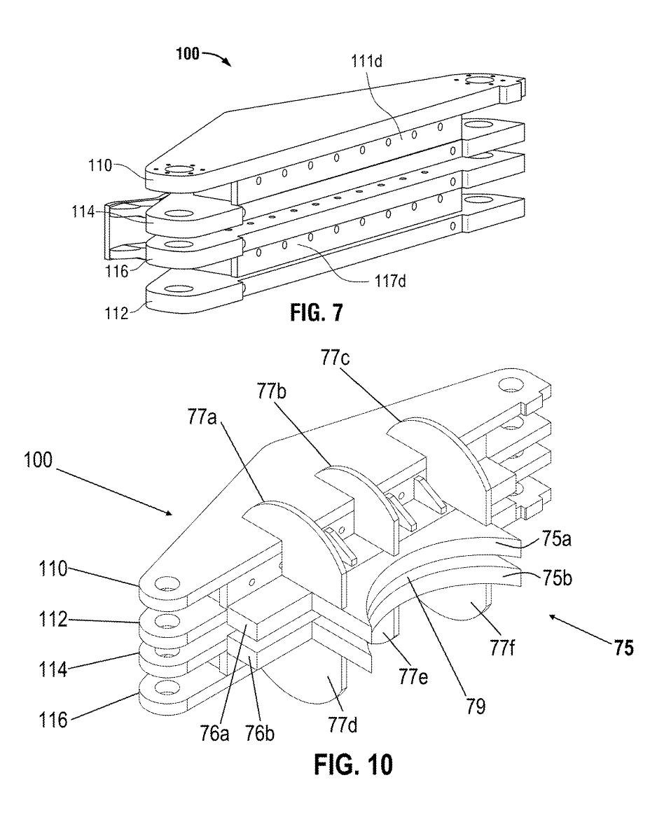

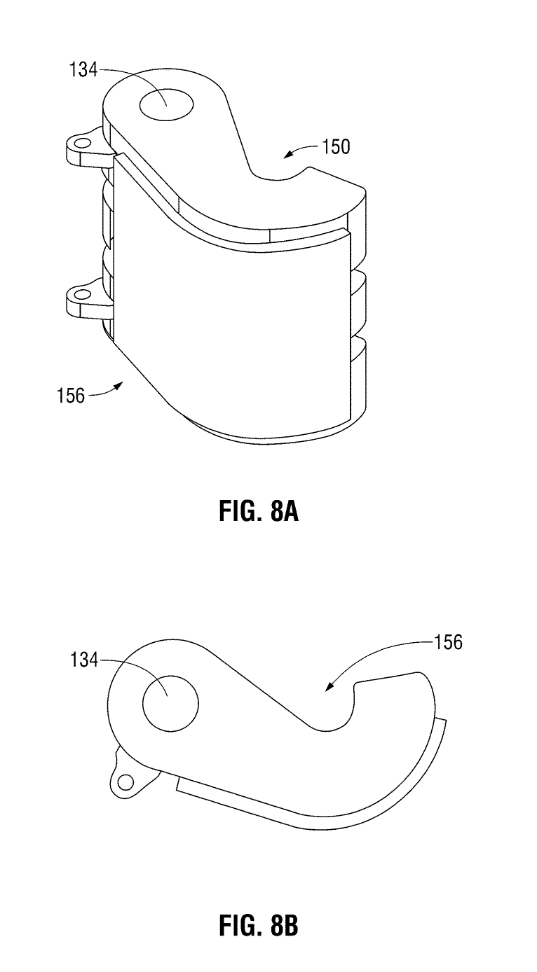

Also in FIGS. 1A and 1B, there is illustrated a gate assembly 100 which is pivotable around a hinge pin 102. FIG. 6 illustrates in an exploded view, the principal parts of the gate assembly 100, and includes an upper plate 110, a lower plate 112, and a pair of intermediate plates 114 and 116. Spacers 111a-111c, 115a-115c, and 117a-117c are illustrated for maintaining separation between the plates. FIG. 7 illustrates the gate assembly 100 after the plates and spacers of FIG. 6 have been assembled together. FIGS. 8A and 8B illustrate a rotatable latch assembly 130 which rotates around a hinge pin 132 illustrated in FIG. 1A. The plates 110, 112, 114, and 116 each has one pivot hole for the hinge pin 102 and one pivot hole for the hinge pin 132. The latch assembly 130 has a pivot hole 134 for receiving the hinge pin 132.

Also in FIG. 1B specifically, there is a centralizer 75, which will be discussed in more detail in FIG. 10.

In the operation of the gate assembly 100 and the latch assembly 130, hydraulic and/or pneumatic power, for example, from the source 11, is used to pivot the gate assembly 100 to the open position by causing the gate assembly 100 to pivot about the hinge pin 102. After the gate assembly is open, the cutting machine 10 is moved via a crane or other lifting device to envelop the part to be cut, for example, the steel casing 42 of FIGS. 2A and 2B. Some embodiments can further include the ability to provide a sensor or mechanical means to close the gate assembly as soon as the casing 42 is touched by the V-shaped plates 60 and 62, whereby hydraulic and/or pneumatic power is used to close the gate assembly 100 and then the rotation of the latch assembly 130 to thereby secure the casing 42 within the cutting machine 10. The latch assembly 130 has a J-shaped profile 150 to latch onto a hinge pin 160 running through the frame member 34, or alternatively, to any other latch pin or mechanism secured to the frame, to secure the gate assembly 130 in the closed position.

The cylinders 12, 14 and 16 are then activated by hydraulic and/or pneumatic power, to move the cutting blade to a position to penetrate or puncture the casing 42 and then to slice and split the casing 42 all the way through. The cutter 30 can partially enter the gate assembly between the plates 114 and 116, or as an option, be stopped just short of the gate assembly, as desired, by using different sized inserts, depending upon the size of the pile or the casing, or the like being cut, to proved an anvil surface against which the pile or casing resides to enable the cut to go completely through the pile or casing.

It should be understood that the cutting machine described herein can be implemented in various sizes to accommodate various sizes of casing, pipe, pilings, or other objects to be cut. It should also be understood that the hydraulic/pneumatic cylinder should be capable of providing over 5000 psi of constant pressure throughout the cutting operation.

The cutting blade, such as those depicted in FIGS. 3A, 3B, 3C, 4A, 4B, and 4C, can be made from metal or any metal alloy as would be known in the art.

In the preferred embodiment, the cutting blade 30 further comprises a blade carrier 38 which is attached to the arms 24, 26, and 28 and is further attached to the cutting blade 30 through the use of bolts, or other like fasteners, wherein the cutting blade 30 is oriented with the cutting edge pointed substantially toward the gate assembly 100.

In further operation of the gate assembly 100 and the latch assembly 130, it is to be understood that hydraulic and/or pneumatic power, for example, from the source 11, is used to pivot the gate assembly through the use of rams having pistons which can be employed either within the members 32 and 34 of the machine 10 or between the plates comprising the gate assembly. The rams are attached to the members or plates of the gate assembly through the use of bolts and/or pins with sufficient rigidity to withstand the forces endured during cutting operations. Such implementation and placement of the rams and pistons within the members or within the gate assembly plates provides additional protection for the rams and pistons from being struck or damaged during operations or transport of the machine 10. Previous attempts by others to design and implement cutting machines with gate assembly rams has yielded poor results, as these previous machines included rams that would protrude outside of the frame and/or gate assembly plates resulting in easily damaged rams during transport or cutting operations. Additionally, these previous attempts by others produced poor results and failures of the rams when placed under stress during cutting operations.

A further embodiment of the machine 10 includes a cutting blade 30 with removable tips 41 and 43 to fit over the puncture point 40 of the cutting blade. As shown in FIGS. 3A & 4A, the removable tips are of a dimension and size to securely fit over the puncture point formed on the cutting blade. The removable tips prevent undue wear and tear upon the puncture point of the cutting blade and increase the lifespan of the cutting blade. The removable tips, as implemented, allow for relatively easy removal from the puncture point of the cutting blade or can be consumed during cutting operations whereby a new removable would be installed on the puncture point before the next cutting operation begins.

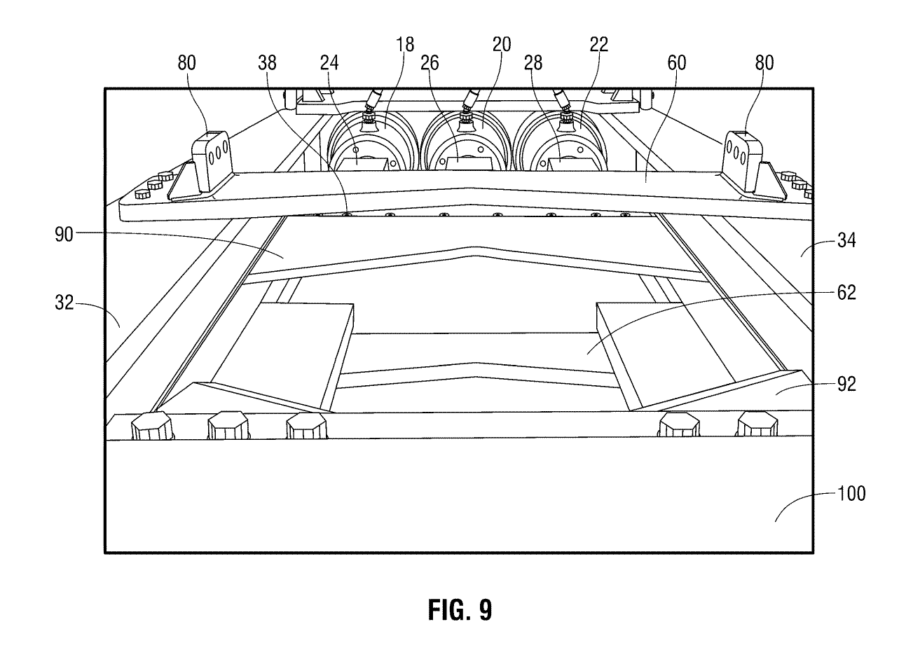

Another embodiment of the machine can include two notched, v-shaped blades, as depicted in FIG. 9, the first notched, v-shaped blade 90 being attached to the blade carrier 38 or directly to the arms 24, 26, and 28. The second notched, v-shaped blade 92 is attached to one or more plates 110, 112, 114, or 116 of the gate assembly 100 or any combination thereof. The two notched, v-shaped blades are mounted in an orientation such that when the first notched, v-shaped blade moves in response to the hydraulic and/or pneumatic cylinders that it extends in such an orientation that it overlaps the second notched, v-shaped blade.

Any of the embodiments contemplated within this disclosure can include a centralizer 75, as shown in FIGS. 1B and 1n more detail in FIG. 10. The centralizer can comprise of a plurality of arcuate members 75a, 75b attached to plates 110, 112, 114 or 116 of the gate assembly 100, or any combination thereof, as shown in FIGS. 1B and 1n more detail in FIG. 10. In an embodiment, centralizer 75 can be attached to the gate assembly 100 by means of a plurality of hooks 77a, 77b, 77c, which can in turn attach to a plate 112, 114, 116 of gate assembly 100. Each of these hooks may be doubled on the underside of the gate assembly (shown as 77d, 77e, 77f). The centralizer may also be implemented in a manner that allows for the cutting blade to pass through an opening 79 formed through at least one of the centralizer portions 75a, 75b to allow the blade to travel linearly through the centralizer.

Centralizer 75 serves the secondary function of keeping the gate assembly 100 clear of any debris created by the cutting action. Spacer bars 76a and 76b, as depicted in FIG. 10, give the arcuate members 75a, 75b an offset from the gate assembly 100 even at their narrowest point, while hooks 77a-77f extend even further out. Each hook 77a-77f can comprise an inward-facing vertical surface for further obstruction of the gate assembly 100 from debris. The centralizer 75 can be mounted in such a fashion that it be removed for different cutting operations, such as needing to accommodate larger sized objects within the frame. Some embodiments however will have the centralizer permanently attached to the attachment points as described above.

The centralizer 75 can be used to allow the frame to be secured to objects of a non-specific diameter, such as in situation where the cutting operations require a smaller diameter object to be cut while there is only one size machine on site. A further use of the centralizer 75 can include allowing the machine and cutting blade or blades make a clean cut through the object where the object would not be in contact with the plates 60 and 62 (shown in FIGS. 5A-5B) and the plates comprising the gate assembly. The centralizer 75 is preferably made of a metal or metal-alloy, but in other embodiments, the centralizer 75 can be made from other materials known in the art.

While these embodiments have been described with emphasis on the embodiments, it should be understood that within the scope of the appended claims, the embodiments might be practiced other than as specifically described herein.

What is claimed is:

1. An apparatus comprising:
a metal frame having a first end and a second end;
cylinders having pistons, wherein the cylinders are mounted proximate to the first end;
a gate assembly mounted proximate to the second end, wherein the gate assembly consists of a plurality of interconnected plates having both spacers therebetween and pivot holes latched with hinge pins to the second end to enable movement between an opened position and a closed position;
at least one additional plate mounted to the metal frame;
a centralizer comprising a first portion and a second portion, wherein the centralizer is mounted to the gate assembly by a plurality of hooks resting on the plurality of interconnected plates, wherein the centralizer is positioned to grip a portion of the circumference of an object during a cutting operation with the metal cutting blade in order to provide a cut through the object, wherein the centralizer obstructs the object from contact with the gate assembly; and
a metal cutting blade linearly moveable within the metal frame through application of hydraulic and/or pneumatic pressure to the pistons of the cylinders, wherein the metal cutting blade comprises a first concave surface, a second concave surface, and a puncture point having a removably attached tip, wherein the puncture point is located at or near a projected intersection of the first concave surface and the second concave surface, and wherein the first concave surface and the second concave surface each comprise a radius of curvature adapted to enable the puncture point to puncture the object, slice the object, or both.

2. The apparatus according to claim 1, wherein the first concave surface and the second concave surface each has a substantially constant radius of curvature.

3. The apparatus according to claim 1, wherein the pivot holes latched with the hinge pins comprise a latch assembly to latch onto the hinge pins running through the metal frame at the second end.

4. The apparatus according to claim 3, wherein latch assembly has a J-shaped profile.

5. The apparatus according to claim 2, wherein the substantially constant radius of curvature is in a range of about 10″ to about 25″.

6. The apparatus according to claim 2, wherein the substantially constant radius of curvature is in a range of about 11.85″ to about 11.91″.

7. The apparatus according to claim 2, wherein the substantially constant radius of curvature is in a range of 23.7″ to 23.82″.

8. An apparatus for cutting metal piles, casing, tubulars, and other objects, having a perimeter, the apparatus comprising:
a metal frame having a first end and a second end;
at least one cylinder and piston assembly mounted at said first end of said frame responsive to hydraulic and/or pneumatic pressure;
a gate assembly mounted in association with said second end of said frame, wherein said gate assembly is movable between an open position for accommodating envelopment of an object by the frame and a closed position for enclosing the object within the frame;
at least one plate disposed between said first end and said second end of said frame;
a centralizer comprising a first portion and a second portion, wherein the centralizer is mounted to the gate assembly by a plurality of hooks resting on the gate assembly, wherein the centralizer is positioned to grip a portion of the circumference of an object during a cutting operation with the metal cutting blade in order to provide a clean cut through the object, wherein the centralizer obstructs the object from contact with the gate assembly; and
a pair of opposed cutting blades, wherein each cutting blade comprises a flat, planar surface and an opposing surface with a beveled cutting edge, and wherein the pair of opposed cutting blades has a notched, v-shaped cutting edge.

9. The apparatus according to claim 8, further comprising a latch pivotably mounted to said gate assembly, wherein said latch comprises a curvature that at least partially encircles a pin within said frame to secure said gate assembly in a closed position.

10. The apparatus according to claim 9, wherein the gate assembly consists of a plurality of interconnected plates having both spacers therebetween and pivot holes, with the latch pivotally mounted to the pivot holes to enable movement between an opened position and a closed position.
